(19) United States
(12) Patent Application Publication
(10) Pub. No.: US 2026/0014584 A1
(43) Pub. Date: Jan. 15, 2026

(54) COMPOUND MODULAR VALVE FOR PRODUCING WIDE PARTICLE CURTAINS WITH ADJUSTABLE THICKNESS AND PROFILE

(71) Applicant: Flowserve Pte. Ltd., Singapore (SG)

(72) Inventors: Paul Jeffrey Parish, Spanish Fork, UT (US); Bradford B. Haines, Spanish Fork, UT (US); Michael P. Nelson, Lehi, UT (US); Matthew Kley Prakke, Raleigh, NC (US); Robert Bruce Irvine, Smithfield, NC (US)

(73) Assignee: Flowserve Pte. Ltd., Singapore (SG)

(21) Appl. No.: 18/766,957

(22) Filed: Jul. 9, 2024

(51) Int. Cl. B05C 5/02; B05C 5/00; B05C 11/10; F24S 60/00

(52) U.S. Cl. CPC B05C 5/0229; B05C 5/005; F24S 60/00; B05C 11/1031

(57) ABSTRACT

A modular particle valve comprises a plurality of aligned and abutted valve modules that dispense particle curtain segments. The curtain segments merge to form a particle curtain having a width that is limited only by the number of included valve modules. Each valve module comprises a particle hopper and a movable element abutting the hopper from below. An actuator causes the moveable element to block or partially open a hopper outlet to provide a curtain segment of variable thickness. The resulting particle curtain can have a thickness that is uniform or shaped and adjusted according to environmental changes. The moveable elements have edges that abut without intervening structures, and in embodiments interlock while permitting separate movements thereof. Individual valve modules can be removed and reinstalled without significantly disturbing the remaining valve modules. Embodiments are incorporated into systems that dry seeds or collect solar energy by heating particles.

### STATEMENT OF GOVERNMENT INTEREST

This invention was made with government support under Contract No. DE-NA0003525 awarded by the United Stated Department of Energy. The United States Government has certain rights in the invention.

### FIELD OF THE INVENTION

The invention relates to valves, and more particularly, to valves for controlling particle flows.

### BACKGROUND OF THE INVENTION

For certain applications, it is necessary to provide a flow of particles as an exposed, wide, thin curtain, so that substantially all of the particles are at, or at least proximate, a front-facing surface of the curtain. Examples include drying of seeds by exposure to sun and wind, high speed review and quality control of particles by machine vision, and solar heating of particles.

As an important example, solar heating of particles is of growing importance in the field of solar energy. In a concentrated solar power (CSP) system, mirrors reflect sunlight onto a receiver that is typically mounted at the top of a tower. In a conventional CSP, the energy from the concentrated sunlight heats a high temperature fluid, such as molten salt. The thermal energy that is captured and transported by the heated fluid can then be used in any of a variety of industrial applications, such as water desalination, enhanced oil recovery, food processing, chemical production, mineral processing, conversion of water into steam for electrical generation, and a variety of other processes.

However, using molten salt to capture solar heat has several disadvantages. For many applications it is desirable for the fluid to reach as high a temperature as possible. Molten salt has temperature limitations in this regard. Molten salt can also be very corrosive on supporting infrastructure, requiring the use of expensive, high temperature, corrosion resistant alloys. Also, if the molten salt temperature drops below its freezing temperature, it contracts and solidifies. Then, when the salt is re-heated and melts, it expands, which can put undue stress on the surrounding structure and can result in a fracture. Start-up and shutdown of a molten salt CSP can also be difficult, and can lead to valve damage during a cool-down and start-up.

Using solid particles instead of a fluid to gather solar energy is an attractive alternative. Suitable particle materials can be selected that are low in cost, durable, and tolerant of very high temperatures. One example would be sintered bauxite particles having average diameters of less than 500 microns. Also, while such particles can be abrasive, they are generally not corrosive, do not undergo phase transitions, and therefore do not expand or contract significantly upon heating and cooling.

The most common approach to providing a particle curtain is to raise the particles to a desired height, for example by using a particle elevator, and then cause the particles to fall downward into a hopper that has a wide and narrow opening or “slit” at the bottom thereof, through which the particles fall as a curtain. Typically, the resulting particle curtain has a fixed, uniform thickness, and a uniform mass flow rate.

However, for applications that expose a conventional particle curtain to wind and/or to solar heating, whether for drying seeds, storing heat, or generating power, the efficiency of the process will vary significantly due to intensity and/or velocity changes in wind, solar intensity, changes in cloud cover, and other ambient variations.

Accordingly, it would be desirable to provide a particle curtain having an adjustable thickness, so as to maximize the efficiency of an associated process under varying conditions. Valves are known that can control and adjust a flow of particles. However, they are generally not large enough, or wide enough, to meet the industrial requirements of many applications, which may require a particle curtain that is 20 meters or greater in width. And even if a particle valve of a known design could be “scaled up” to meet these requirements, it would be very large and heavy, making it very difficult and expensive to install and maintain, and rendering this approach largely impractical.

Furthermore, for some applications the exposure to wind and/or sunlight at various locations along the width of the curtain will vary, due to changes in the wind direction, as well as diurnal and seasonal changes of solar angle. As a result, for many applications, the intensity distribution of the applied sun or wind will not, in general, be uniform across the particle curtain, and will vary over time.

What is needed, therefore, is a control mechanism for providing a particle curtain having an adjustable thickness, wherein the control mechanism can be scaled to produce arbitrarily wide particle curtains, is readily manufactured, installed, and serviced, and preferably enables adjustment of a thickness profile of the particle curtain.

### SUMMARY OF THE INVENTION

The present invention is a control mechanism that is able to create an arbitrarily wide particle curtain, and to adjust its thickness as needed. Specifically, the control mechanism is a compound, modular valve that is readily manufactured, installed, and serviced. In embodiments, the disclosed compound valve enables adjustment of the thickness profile of the particle curtain.

The disclosed compound particle valve comprises a plurality of individual particle valves, also referred to herein as “valve modules,” that are arranged in a laterally abutting relationship. Each of the individual valve modules controls a flow of particles through a lateral slot of variable width, thereby providing a curtain “segment” of comparatively modest width. By abutting the valve modules together laterally without intervening gaps, the curtain segments are combined to form a single particle curtain having a width that is limited only by the number of valve modules that are included in the compound valve. In embodiments, all of the valve modules are identical to each other.

Due to the modular nature of the disclosed compound valve, it is not necessary to manufacture or transport the valve as a whole. Instead, the valve modules are separately manufactured, transported, and assembled together in place to form the resulting compound valve at its desired location. In embodiments, the disclosed compound valve can produce very wide particle curtains, for example up to 20 meters or more in width. The disclosed compound valve thereby enables the thickness of a particle curtain to be adjusted according to variations in the ambient environment, such as changes in the intensity and/or direction of the sun and/or the ambient airflow (i.e. wind). For example, in a concentrated solar power (CSP) system that heats a particle curtain, the particle curtain can be made thicker on sunny days that provide high amounts of reflected sunlight, so as to capture as much solar energy as possible, and can be made thinner on overcast days that provide less reflected sunlight.

Each of the disclosed valve modules comprises a hopper that is configured to direct particles to an opening provided at the bottom of the hopper, referred to herein as the hopper outlet. Each of the valve modules further includes a movable element that extends below and at least partially blocks the hopper outlet. The valve module also comprises an actuator that can transition the moveable element toward and away from a distal boundary of the hopper outlet, thereby forming a “slot” of variable gap size through which particles can fall to form a curtain segment. The valve modules are configured such that they can be installed side-by-side with the lateral edges of the moveable elements substantially in contact with each other, thereby producing a particle curtain without gaps between the individual curtain segments.

In embodiments, the valve module actuators are separately controlled, thereby enabling adjustment of the thickness “profile” of the particle curtain. For example, if sunlight is being used to dry a curtain of grain particles, and if an eastern side of the particle curtain receives more sunlight in the morning, while a western side of the particle curtain receives more sunlight in the afternoon, then by appropriate separate adjustments of the thicknesses of the curtain segments, embodiments of the present invention are able to transition the particle curtain from being thicker on its eastern side to being thicker on its western side.

In embodiments, the valve modules are configured such that they can be separately removed from the compound valve and reinstalled with little if any disturbance of the remainder of the compound valve. This feature can significantly reduce the time and cost that is required to maintain the compound particle valve, by enabling the valve modules to be separately repaired or replaced as needed. In some of these embodiments, removal and reinstallation of a valve module requires access only to the front, or only to the rear, of the compound valve, thereby simplifying the support structure that is required by the compound valve.

A first general aspect of the present invention is a modular particle valve configured to produce a particle curtain. The particle valve includes a support structure, and a plurality of valve modules supported by the support structure. Each of the valve modules includes a hopper assembly comprising a hopper configured to contain particles, a hopper outlet at a bottom of the hopper, a moveable element abutting the hopper outlet from below, the moveable element comprising a hopper abutting section that is distally terminated by a forward edge thereof, and an actuator connected by a linkage to the moveable element, the actuator being configured to move the moveable element such that the forward edge of the hopper abutting section of the moveable element approaches and recedes from a distal boundary of the hopper outlet, forming an open slot therebetween having a variable gap size through which the particles can fall from the hopper to form a curtain segment. The valve modules are installed in the support structure in an aligned, adjacent, laterally abutting relationship that does not interpose any element of the hoppers or support structure between the hopper abutting sections of the moveable elements of the adjacent valve modules of the plurality of valve modules, thereby causing the curtain segments to substantially merge together into a continuous particle curtain.

In embodiments, the hoppers are bounded by side walls that do not extend downward to the hopper outlets, thereby causing the sides of the hopper outlets to be open, and allowing the particles to be continuously distributed over the hopper outlets between adjacent ones of the valve modules, such that when the modular valve is assembled with the valve modules aligned and abutted, the hopper outlets substantially combine into a single, unified particle outlet that extends across a full width of the modular valve.

In any of the above embodiments, the valve modules can be identical to each other.

In any of the above embodiments, at least one of the valve modules can be removable from the support structure and re-installable in the support structure without substantially impacting a remainder of the valve modules, except for detachment therefrom and reattachment thereto. In some of these embodiments the removal and the reinstallation of the at least one of the valve modules requires access only to distal ends or only to proximal ends of the valve modules.

In any of the above embodiments, the actuators can be separately controllable, thereby enabling variation of a thickness of the particle curtain along its width.

In any of the above embodiments, each of the hopper abutting sections of the moveable elements can comprise at least one interlocking side edge that is configured to interlock with an interlocking side edge of an abutting one of the hopper abutting sections, thereby reducing leakage of the particles between the hopper abutting sections, while allowing abutting ones of the hopper abutting sections to move distally and proximally relative to each other. In some of these embodiments the interlocking side edges of the hopper abutting sections are separated from each other by a labyrinth gap comprising at least one vertical segment thereof and at least one horizontal segment thereof. In some of these embodiments, the labyrinth gap is wider than an average diameter of the particles. In any of these embodiments, at least one of the horizontal segments of the labyrinth gap can be longer than an average diameter of the particles.

In any of the above embodiments, at least one of the hopper assembly, the linkage, and the actuator of at least one of the valve modules can be suspended from above by mounting hangers that are attached to the support structure.

In any of the above embodiments, the hopper abutting section of at least one of the moveable elements can be substantially horizontal, and can be translated distally and proximally by its associated actuator.

In any of the above embodiments, at least one of the moveable elements can be suspended from a corresponding pivot, and its associated actuator can cause the forward edge of the hopper abutting section of the moveable element to approach and recede from the distal boundary of the hopper outlet by rotating the moveable element about the pivot.

A second general aspect of the present invention is a non-transient storage medium readable by a computing device, wherein the computing device is configured to control the actuators of a modular valve according to any embodiment of the first general aspect, and the non-transient storage medium includes instructions that, when executed by the computing device, cause the computing device to direct the actuator of at least one of the modular valves to position the moveable element of the associated valve module such that particles contained in the hopper of the valve module fall through the open slot formed between the forward edge of the hopper abutting section of the moveable element of the valve module and the distal boundary of the hopper outlet of the valve module, thereby forming a curtain segment.

In any of the above embodiments, the instructions can cause the computing device to direct the actuators of a group of adjacent valve modules of the plurality of valve modules to position the moveable elements of the group of adjacent valve modules such that particles contained in the hoppers of the group of adjacent valve modules form curtain segments by falling through the open slots formed between the forward edges of the hopper abutting section of the moveable elements of the group of adjacent valve modules and the distal boundaries of the hopper outlets of the group of adjacent valve modules, the curtain segments formed by the group of adjacent valve modules substantially merging together into a continuous particle curtain. In some of these embodiments, the instructions cause the computing device to direct the actuators of the group of adjacent valve modules of the plurality of valve modules to position the moveable elements of the group of adjacent valve modules such that a thickness of the continuous particle curtain is uniform across the continuous particle curtain. In any of these embodiments, the instructions can cause the computing device to direct the actuators of the group of adjacent valve modules of the plurality of valve modules to position the moveable elements of the group of adjacent valve modules such that a thickness of the continuous particle curtain varies across the continuous particle curtain. In some of these embodiments, the instructions cause the computing device to direct the actuators of the group of adjacent valve modules of the plurality of valve modules to periodically or continuously reposition the moveable elements of the group of adjacent valve modules such that the non-uniformity of the thickness of the continuous particle curtain is adjusted according to changes in the ambient environment.

A third general aspect of the present invention is a solar energy collecting apparatus, which comprises a modular valve according to the first general aspect, at least one solar collector configured to capture sunlight and direct the captured sunlight onto the continuous particle curtain formed by the modular valve, and a particle collector configured to collect the particles of the continuous particle curtain after the exposure thereof to the collected sunlight, and to extract heat from the collected particles, said heat being generated by said directing of the collected sunlight onto the continuous particle curtain.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a perspective view drawn to scale of a first exemplary embodiment of the present invention;

FIG. 2 is a side view, drawn to scale, of a valve module included in the first exemplary embodiment;

FIG. 3 is a perspective view from above, drawn to scale, of the valve module of FIG. 2;

FIG. 4 is a perspective view from below, drawn to scale, of the valve module of FIG. 2;

FIG. 5A is a simplified side view, drawn to scale, of the valve module of FIG. 2, shown with the moveable element extended to prevent forming of a particle curtain;

FIG. 5B is a simplified side view, drawn to scale, of the valve module of FIG. 5A, shown with the moveable element withdrawn to permit forming of a particle curtain;

FIG. 6A is a simplified perspective view from above, drawn to scale, of the moveable element of the valve module of FIG. 5A;

FIG. 6B is a simplified perspective view from above, drawn to scale, of the moveable element of the valve module of FIG. 5B;

FIG. 6C is a simplified view from above, drawn to scale, of the moveable elements of the three valve modules of FIG. 1, positioned to form a particle curtain having a shaped thickness profile;

FIG. 7 is a sectional view, drawn to scale, of the hopper assembly and moveable element of the valve module of FIG. 2;

FIG. 8A is a front view, drawn to scale, of an abutting pair of the valve modules of FIG. 1;

FIG. 8B is an enlarged view, drawn to scale, of the abutting region of the moveable elements of FIG. 8A, showing the edges of the hopper abutting sections of the moveable elements interlocked and forming a labyrinth gap therebetween.

FIG. 9 is a perspective view drawn to scale of a second exemplary embodiment of the present invention;

FIG. 10 is a perspective view from above, drawn to scale, of a valve module included in the second exemplary embodiment;

FIG. 11 is a side view, drawn to scale, of the valve module of FIG. 10;

FIG. 12 is a side view, drawn to scale, of the valve module of FIG. 11, shown with the moveable element omitted;

FIG. 13 is a perspective view from below, drawn to scale, of the valve module of FIG. 10;

FIG. 14A is a simplified side view, drawn to scale, of the valve module of FIG. 10, shown with the moveable element rotated distally to prevent forming of a particle curtain;

FIG. 14B is a simplified side view, drawn to scale, of the valve module of FIG. 14A, shown with the moveable element rotated proximally to permit forming of a particle curtain;

FIG. 15A is a front view, drawn to scale, of an abutting pair of the valve modules of FIG. 9; and

FIG. 15B is an enlarged view, drawn to scale, of the abutting region of the moveable elements of FIG. 15A, showing the edges of the hopper abutting sections of the moveable elements interlocked and forming a labyrinth gap therebetween.

### DETAILED DESCRIPTION

The present invention is a control mechanism that is able to create an arbitrarily wide particle curtain, and to adjust its thickness as needed. Specifically, the control mechanism is a compound, modular valve that is readily manufactured, installed, and serviced. In embodiments, the disclosed compound valve enables adjustment of the thickness profile of the particle curtain.

The disclosed compound particle valve comprises a plurality of individual particle valves, also referred to herein as “valve modules,” that are arranged in a laterally abutting relationship. Each of the individual valve modules controls a flow of particles through a lateral slot of variable width, thereby providing a curtain “segment” of comparatively modest width. By abutting the valve modules together laterally without intervening gaps, the curtain segments are combined to form a single particle curtain having a width that is limited only by the number of valve modules that are included in the compound valve. In embodiments, all of the valve modules are identical to each other.

Each of the disclosed valve modules comprises a hopper that is configured to direct particles to an opening provided at the bottom of the hopper, referred to herein as the hopper outlet. Each of the valve modules further includes a movable element that extends below and at least partially blocks the hopper outlet. The moveable elements can be transitioned toward and away from a distal boundary of the hopper outlet, thereby forming a “slot” of variable gap size through which particles can fall to form a curtain segment. The valve modules are configured such that they can be installed side-by-side with the lateral edges of the moveable elements substantially in contact with each other, thereby producing a particle curtain without gaps between the individual curtain segments.

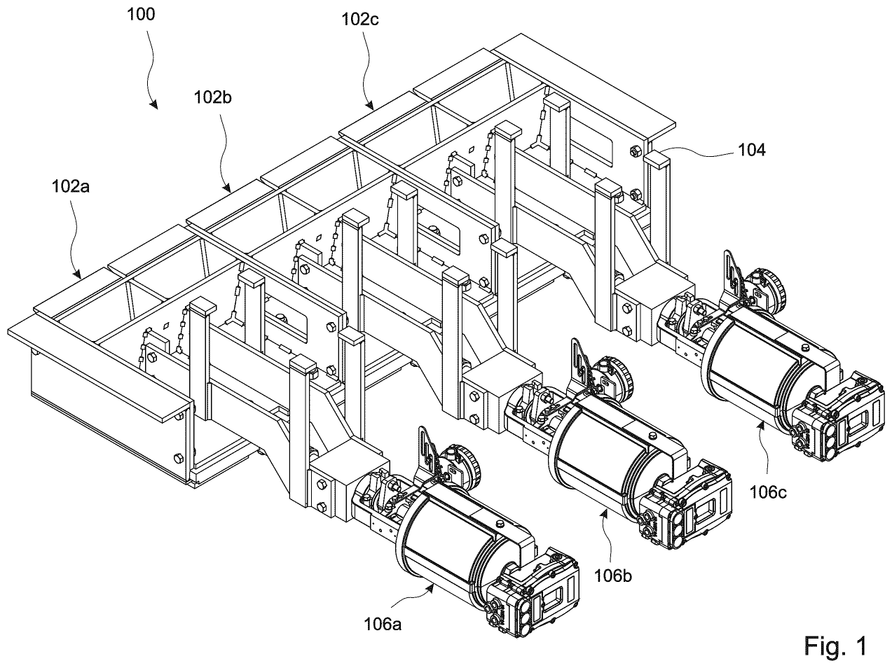

FIG. 1 is a perspective view from above of a first exemplary embodiment of the present invention. In the illustrated embodiment, the compound valve 100 comprises three identical valve modules 102a, 102b, 102c that are abutted side-by-side, and suspended from above by mounting hangers 104 attached to an overhanging support structure (not shown). Each of the valve modules comprises an actuator 106a, 106b, 106c that is attached from below to the support structure.

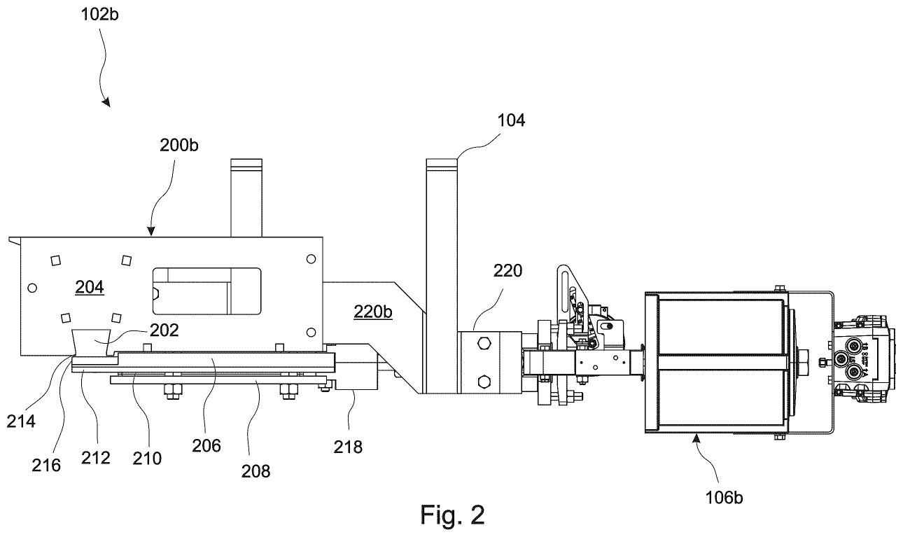

A side view of an individual valve module 102b according to the first exemplary embodiment is presented in FIG. 2. It can be seen that the valve module 102b in the illustrated embodiment includes a hopper assembly 200b that comprises a particle hopper 202 configured to direct particles to an opening at the bottom of the hopper 202, referred to herein as the hopper “outlet.” The hopper 202 is laterally bounded by side walls 204 that do not extend to the hopper outlet, causing the sides of the hopper outlet to be open, and allowing particles to be continuously distributed between the hopper outlets of adjacent hoppers 202. As a result, when the compound valve 100 is assembled and the valve modules 102a, 102b, 102c are aligned and abutted, their hopper outlets substantially combine into a single, unified particle outlet that extends across the full width of the compound valve 100, so that there is no gap between the particle curtain segments produced by the valve modules 102a, 102b, 102c.

In the first exemplary embodiment, the movable element 206 rests upon and slides horizontally over an underlying floor 208 that is suspended below the movable element 206. Sliding of the movable element 206 is facilitated by “slide strips” 210 interposing between the movable element 206 and the floor 208.

A forward “hopper abutting” section 212 of the movable element 206 abuts and closes the hopper outlet from below. A leading edge 216 of the hopper abutting section 212 is parallel to a distal boundary 214 of the hopper outlet, such that horizontal translation of the movable element 206 creates a slot opening of variable gap size at the bottom of the hopper 202, thereby causing particles falling through the slot to form a particle curtain segment. In FIG. 2, the hopper abutting section 212 has been transitioned such that its leading edge 216 is below and beyond the distal edge 214 of the hopper outlet, thereby stopping the flow of particles.

The actuator 106b of the valve module is connected to the moveable element 206 by a linkage 218. In the illustrated embodiment, the linkage 218 is suspended from above by the mounting hangers 104 that are attached to the overhanging support structure.

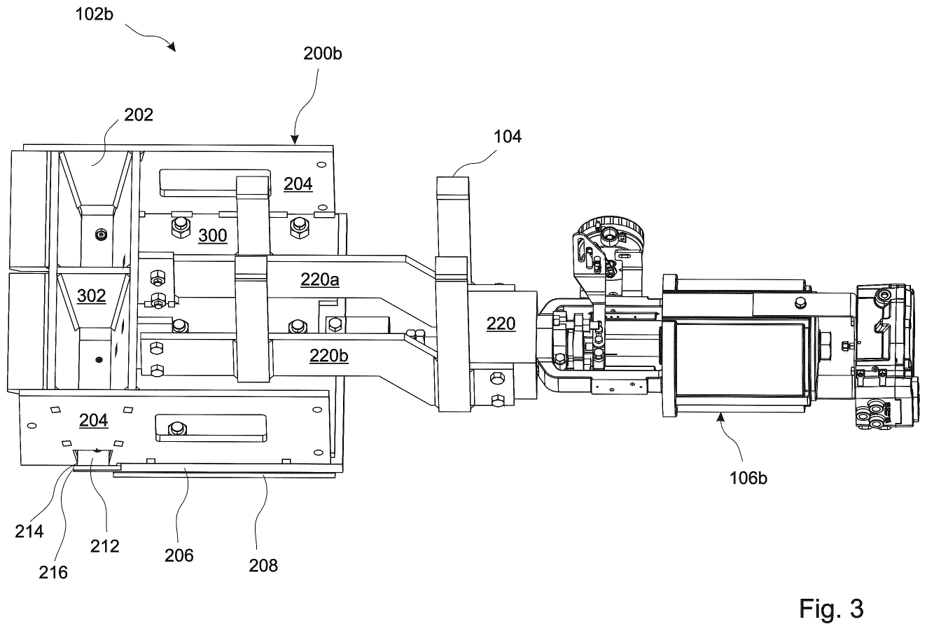

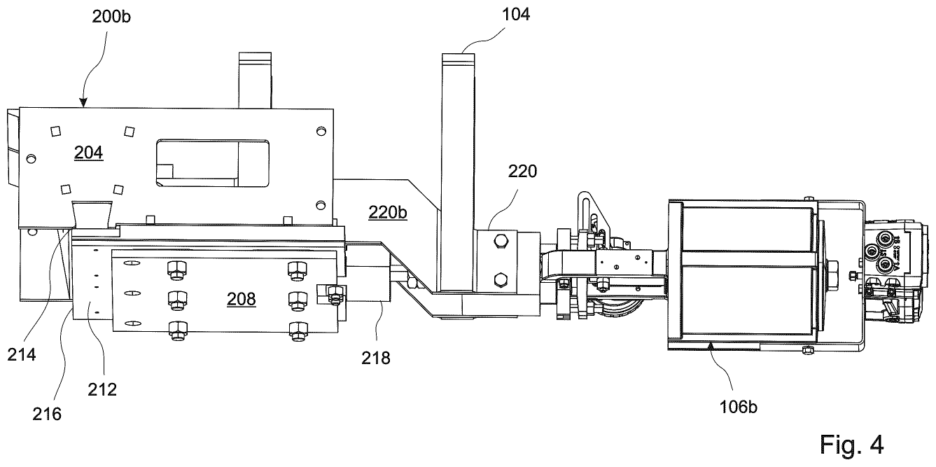

FIG. 3 is a perspective view from above of the valve module of FIG. 2, and FIG. 4 is a perspective view from below of the valve module of FIG. 2. It can be seen in FIG. 3 that the hopper assembly 200b in this embodiment includes a bottom plate 300 and that the hopper 202 includes a central wall 302 that divides the hopper 202 into two adjacent compartments, for improved structural support. Similarly, the linkage support structure 220, which is also supported by the mounting hangers 104, is divided within the hopper assembly into two parallel segments 220a, 220b.

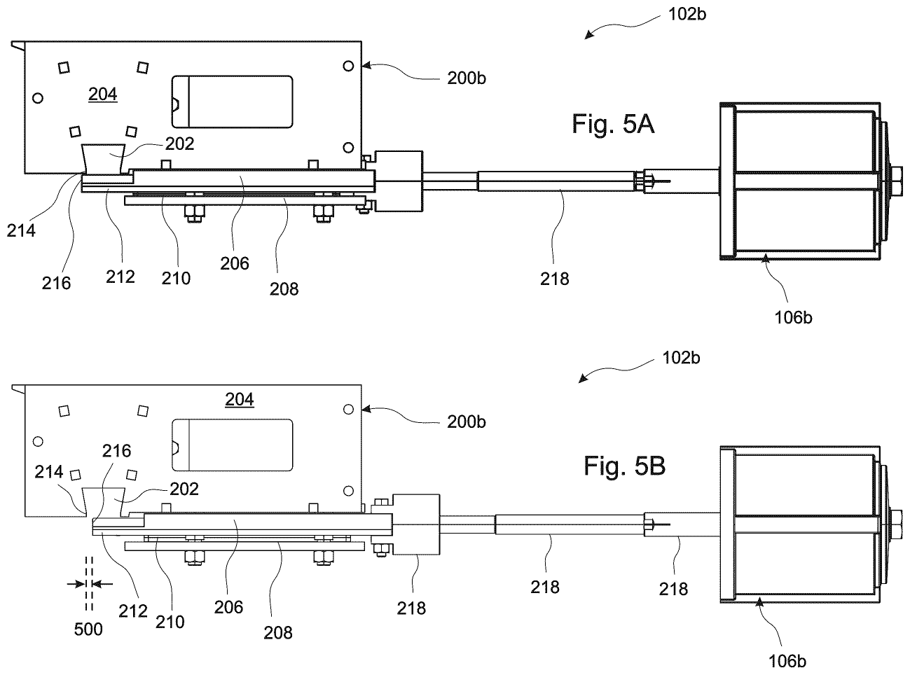

FIGS. 5A and 5B are simplified side views of the valve module 102b of the first exemplary embodiment, in which some of the supporting structure has been omitted to simplify illustration of the basic functioning of the module 106b. In FIG. 5A, the moveable element 206 is positioned fully forward, thereby closing the hopper outlet. In FIG. 5B, the actuator 106b has pulled the movable element 206 proximally away from the distal edge 214 of the hopper outlet, thereby creating an open slot 500 through which particles can fall from the hopper 202 to form a curtain segment.

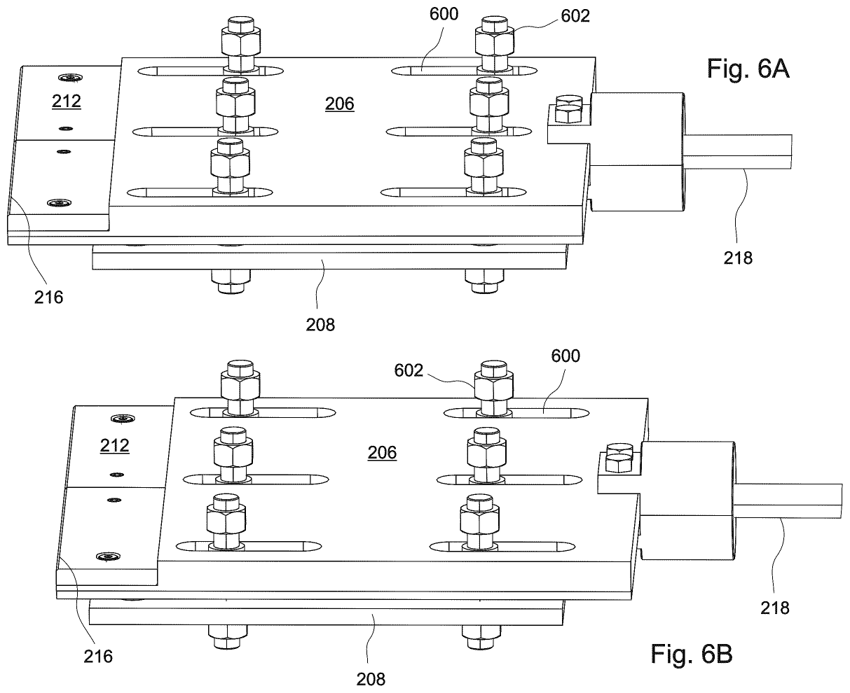

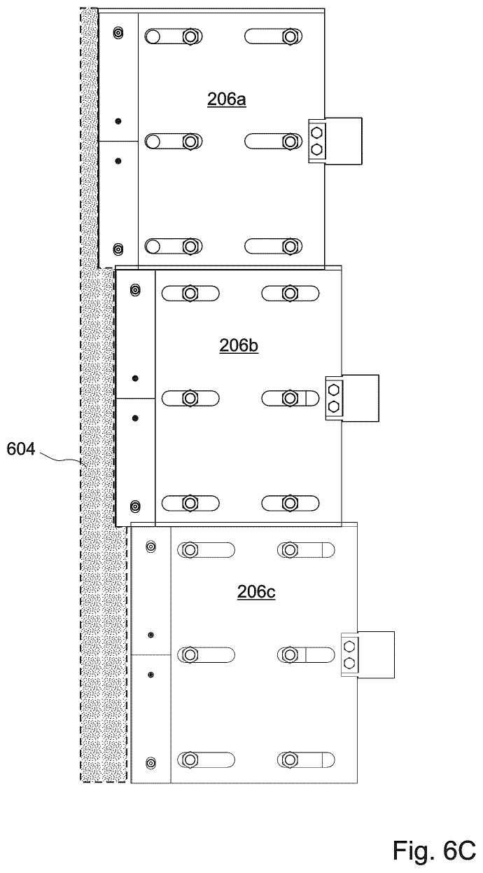

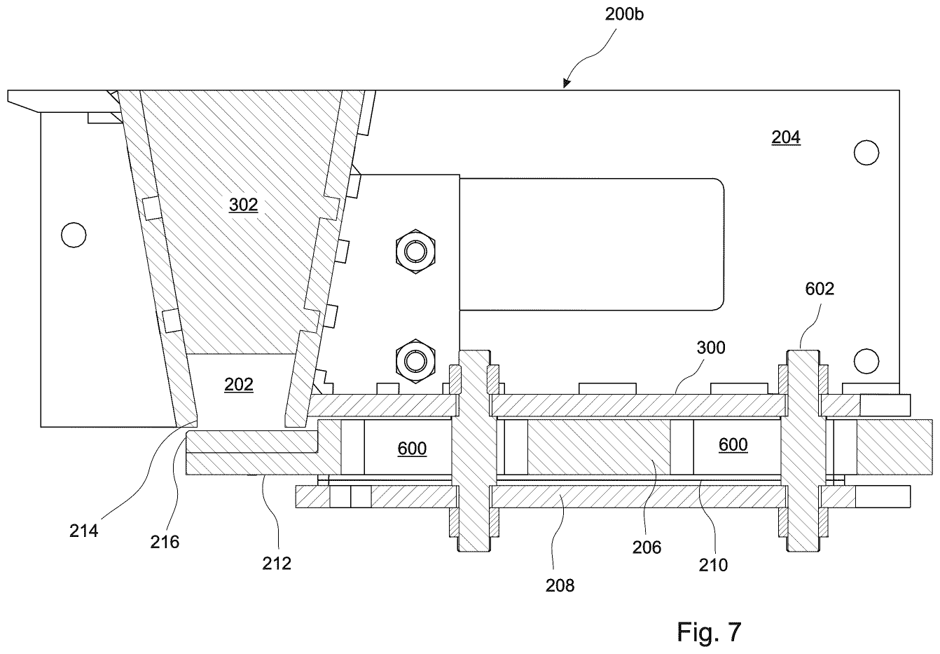

FIGS. 6A and 6B are perspective view of the moveable element 206 and underlying floor 208 of the exemplary embodiment, shown with the moveable element 206 extended distally in FIG. 6A and moved proximally in FIG. 6B. It can be seen in these figures that slots 600 are provided in the moveable element 206 through which supporting rods 602 extend to attach the underlying floor 208 to the bottom plate 300 of the hopper assembly 200b (not shown in FIGS. 6A and 6B) without impeding the sliding of the moveable element 206. This attachment of the underlying floor 208 to the bottom plate 300 of the hopper assembly 204 can be seen in the sectional view of FIG. 7, where the section plane passes through the central wall 302 of the hopper 202.

FIG. 6C is a top view of the moveable elements 206a, 206b, 206c of all three of the valve modules 102a, 102b, 102c of FIG. 1, with the remainder of the compound valve 100 omitted. The actuators 106a, 106b, 106c of the first exemplary embodiment are separately controlled, and in FIG. 6C they have positioned the moveable elements 206a, 206b, 206c at progressively more distal locations, so that the resulting particle curtain 604 has a non-uniform curtain profile that is narrower at the top, and wider at the bottom.

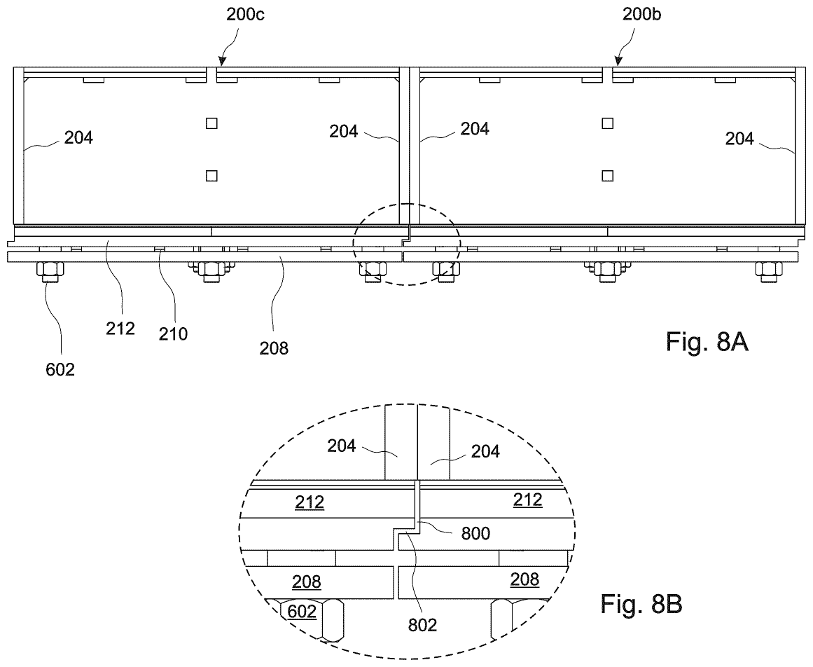

FIG. 8A is a front view of the abutting hopper assemblies 200c, 200b of two of the valve modules 102c, 102b of FIG. 1. FIG. 8B is an enlargement of the abutting region of the hoper abutting sections 212 of the movable elements 206 and the underlying floors 208 of the two hopper assemblies 200c, 200b. It can be seen in FIG. 8B that the hopper abutting sections 212 of the moveable elements 206 overlap in an interlocking “tongue and groove” arrangement that enables them to be separately moved proximally and distally relative to each other by their respective actuators 106b, 106c, while greatly reducing any leakage of particles through the labyrinth gap 800 that separates them. In embodiments, the labyrinth gap 800 is significantly wider than the average diameter of the particles, thereby avoiding any jamming of the moveable elements 206 by the particles in the labyrinth gap 800. In various embodiments, the labyrinth gap 800 includes at least one vertical segment thereof, and at least one horizontal segment thereof.

The labyrinth gap 800 of the illustrated embodiment includes two vertical segments, and a horizontal segment 802 therebetween. The horizontal segment 802 is significantly longer than the average particle diameter, such that those particles that do enter the labyrinth gap 800 will tend to accumulate and remain within the horizontal segment 802 and the first vertical segment of the labyrinth gap 800, filling and substantially “plugging” the labyrinth gap 800 with accumulated particles, and reducing entry of additional particles into the labyrinth gap 800, with relatively few of the particles falling through to the underlying floor 208.

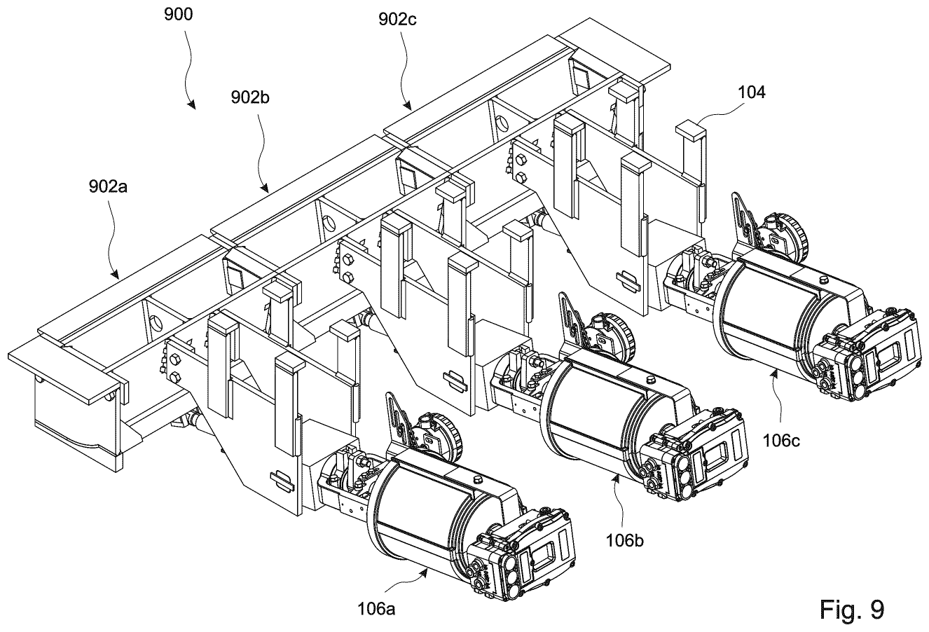

FIG. 9 is a perspective view of a second exemplary embodiment of the present invention. As in FIG. 1, the compound valve 900 of the second exemplary embodiment comprises three identical valve modules 902a, 902b, 902c that are abutted side-by-side, and suspended from above by mounting hangers 104 that are attached to an overhanging support structure (not shown). Each of the valve modules 902a, 902b, 902c comprises an actuator 106a, 106b, 106c that is attached from below to the support structure.

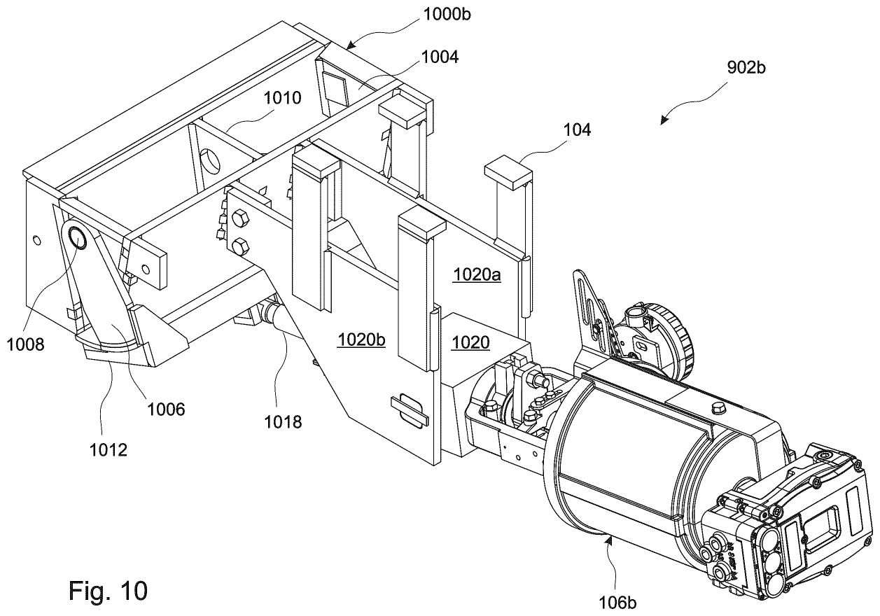

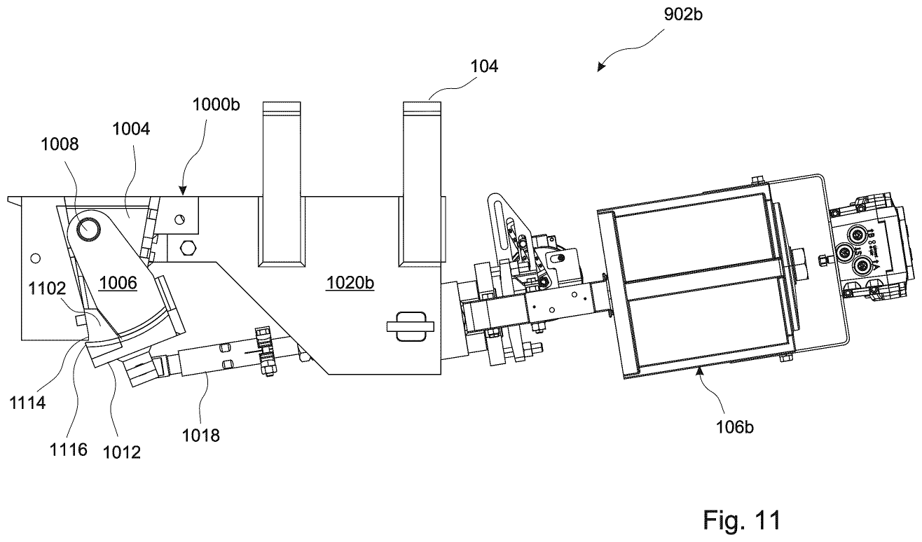

A perspective view from above of an individual valve module 902b according to the second exemplary embodiment is presented in FIG. 10, and a side view of the same valve module 902b is presented in FIG. 11. The valve module 902b in the illustrated embodiment includes a hopper assembly 1000b that comprises a particle hopper 1102 configured to direct particles to a hopper outlet at the bottom of the hopper 1102. The hopper 1102 is laterally bounded by side walls 1004 that do not extend to the hopper outlet, causing the sides of the hopper outlet to be open, and allowing particles to be continuously distributed between the hopper outlets of adjacent valve modules 902a, 902b, 902c. As a result, when the compound valve 900 is assembled and the valve modules 902a, 902b, 902c are aligned and abutted, their hopper outlets substantially combine into a single, unified particle outlet that extends across the full width of the compound valve 900, so that there is no gap between the particle curtain segments produced by the valve modules 902a, 902b, 902c.

In the second exemplary embodiment, the movable element 1006 is connected to the actuator 106b by a linkage 1018, and is rotatably supported by a pivot 1008 that is included in the hopper assembly 1000b. As in the first exemplary embodiment, the hopper 1102 in the second exemplary embodiment is divided into two parts by a central wall 1010 for added structural support. Similarly, a portion of the linkage support structure 1020 is divided into two halves 1020a, 1020b.

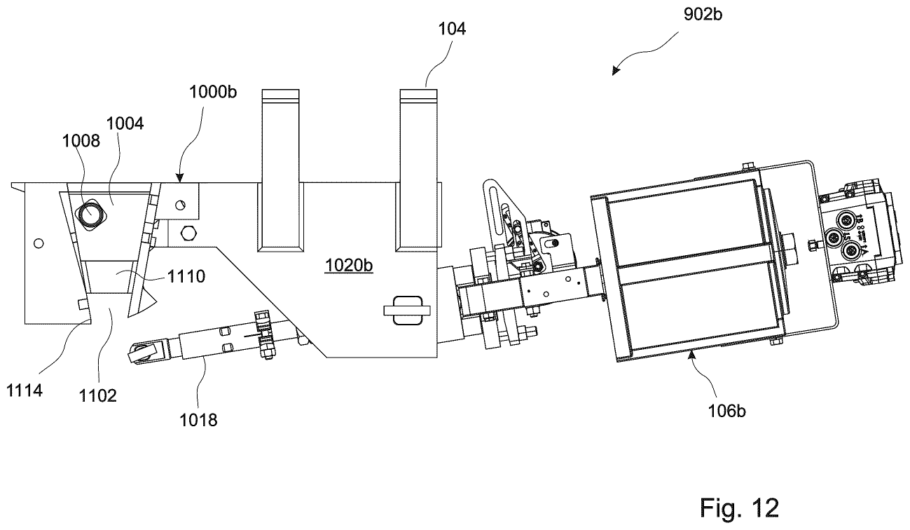

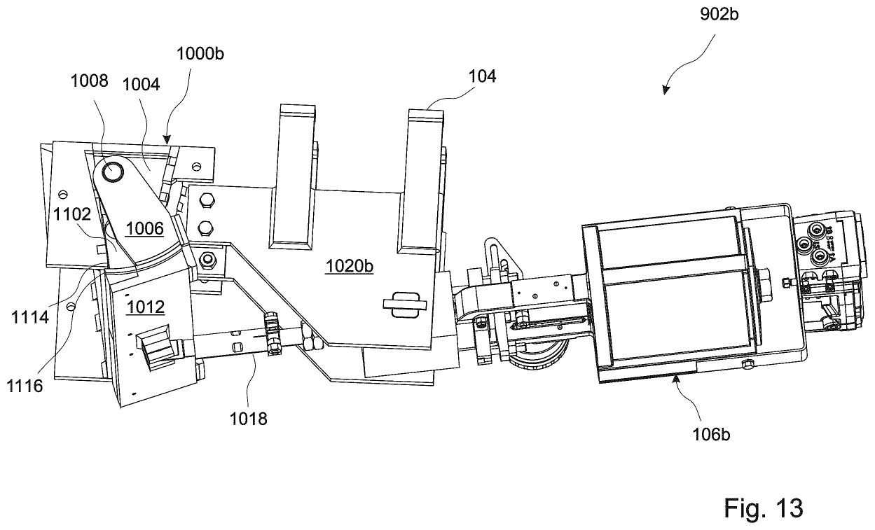

With continuing reference to FIG. 11, when the moveable element 1006 is rotated distally forward, a leading front edge 1114 of a lower, “hopper abutting” section 1012 of the moveable element 1006 is configured to pass under the hopper outlet in an abutting relationship that closes the hopper outlet and stops the flow of particles. FIG. 12 is a side view of the valve module 902b of FIGS. 10-11, in which the moveable element 1006 has been omitted so that the hopper outlet is more clearly visible. FIG. 13 is a perspective view from below of the valve module 902b of FIGS. 10-12.

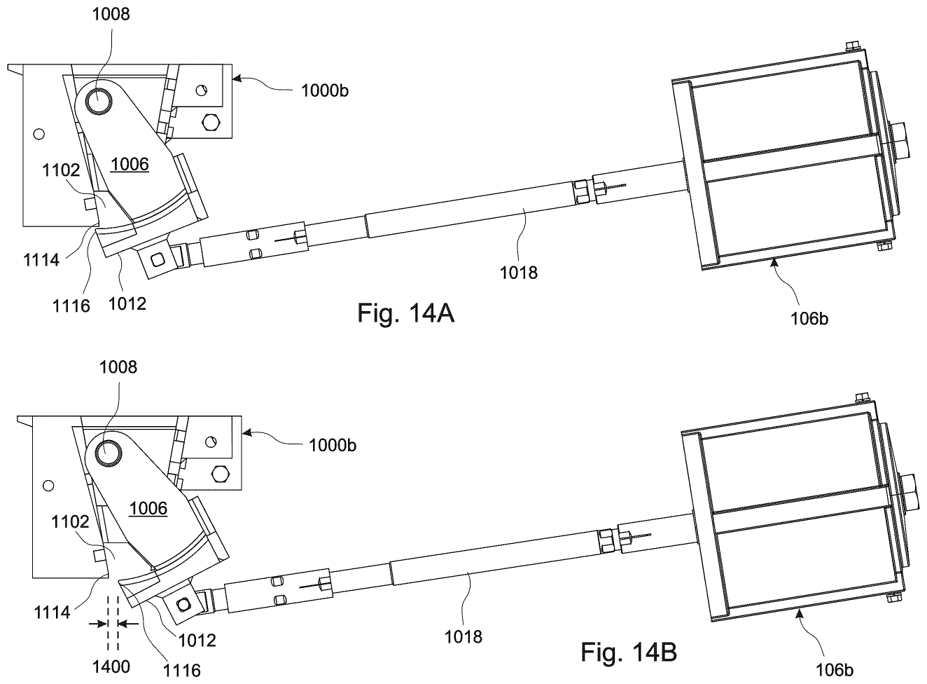

FIGS. 14A and 14B are simplified side views of the valve module 902b of the second exemplary embodiment, in which the linkage supporting structure 1020 has been omitted to simplify illustration of the basic functioning of the valve module 906b. In FIG. 14A, the moveable element 1006 is rotated fully forward, thereby fully closing the hopper outlet. In FIG. 14B, the actuator 106b has pivoted the movable element 1006 proximally away from the distal edge 1114 of the hopper outlet, thereby creating an open slot 1400 through which particles can fall from the hopper 1102 to form a curtain segment.

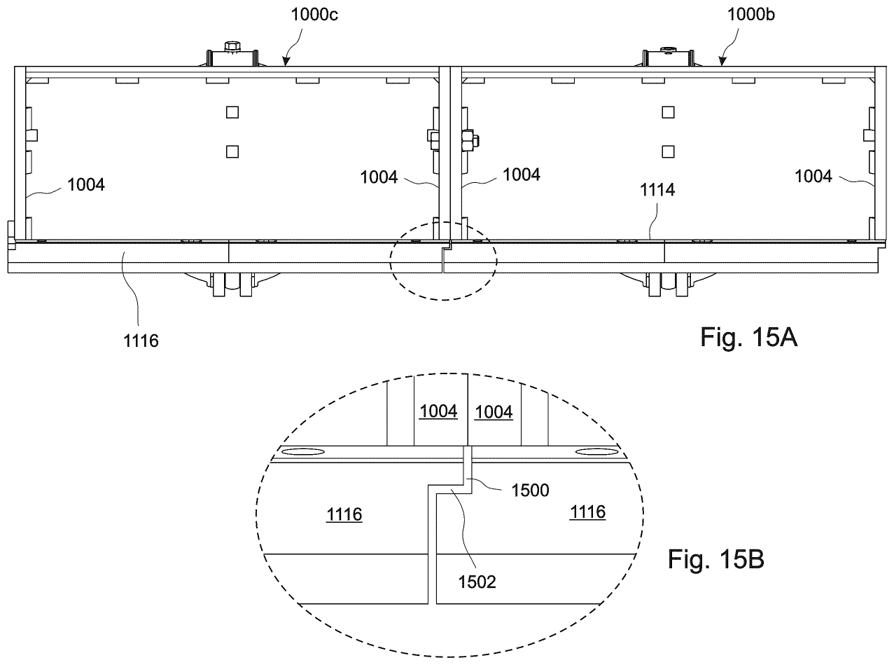

FIG. 15A is a front view of the abutting hopper assemblies 900c, 900b of two of the valve modules 902c, 902b of FIG. 9, shown side-by-side. FIG. 15B is an enlargement of the abutting region of the hopper abutting sections 1012 of the movable elements 1006 of the two hopper assemblies 900c, 900b. It can be seen in FIG. 15B that the lower, hopper abutting sections 1012 of the moveable elements 1006 overlap in an interlocking “tongue and groove” arrangement that enables them to be separately moved proximally and distally relative to each other by their respective actuators 106b, 106c, while greatly reducing any leakage of particles through the labyrinth gap 1500 that separates them. In embodiments, the labyrinth gap 1500 is significantly wider than the average diameter of the particles, thereby avoiding any jamming of the moveable elements 1006 by the particles in the labyrinth gap 1500. In various embodiments, the labyrinth gap 1500 includes at least one vertical segment thereof, and at least one horizontal segment thereof.

The labyrinth gap 1500 of the illustrated embodiment includes two vertical segments, and a horizontal segment 1502 therebetween. The horizontal segment 1502 is significantly longer than the average particle diameter, such that those particles that do enter the labyrinth gap 1500 will tend to accumulate and remain within the horizontal segment 1502 and the first vertical segment of the labyrinth gap 1500, filling and substantially “plugging” the labyrinth gap 1500 with accumulated particles, and reducing entry of additional particles into the labyrinth gap 1500, with relatively few of the particles falling through. Separate rotation of abutting moveable elements 1006 is enabled in embodiments by precise alignment of the pivots 1008 of the moveable elements 1006.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

Although the present application is shown in a limited number of forms, the scope of the disclosure is not limited to just these forms, but is amenable to various changes and modifications. The present application does not explicitly recite all possible combinations of features that fall within the scope of the disclosure. The features disclosed herein for the various embodiments can generally be interchanged and combined into any combinations that are not self-contradictory without departing from the scope of the disclosure. In particular, the limitations presented in dependent claims below can be combined with their corresponding independent claims in any number and in any order without departing from the scope of this disclosure, unless the dependent claims are logically incompatible with each other.

What is claimed is:

1. A modular particle valve configured to produce a particle curtain, the particle valve comprising:
a support structure; and
a plurality of valve modules supported by the support structure, each of the valve modules comprising:
a hopper assembly comprising a hopper configured to contain particles;
a hopper outlet at a bottom of the hopper;
a moveable element abutting the hopper outlet from below, the moveable element comprising a hopper abutting section that is distally terminated by a forward edge thereof; and
an actuator connected by a linkage to the moveable element, the actuator being configured to move the moveable element such that the forward edge of the hopper abutting section of the moveable element approaches and recedes from a distal boundary of the hopper outlet, forming an open slot therebetween having a variable gap size through which the particles can fall from the hopper to form a curtain segment;
wherein the valve modules are installed in the support structure in an aligned, adjacent, laterally abutting relationship that does not interpose any element of the hoppers or support structure between the hopper abutting sections of the moveable elements of the adjacent valve modules of the plurality of valve modules, thereby causing the curtain segments to substantially merge together into a continuous particle curtain.

2. The modular particle valve of claim 1, wherein the hoppers are bounded by side walls that do not extend downward to the hopper outlets, thereby causing the sides of the hopper outlets to be open, and allowing the particles to be continuously distributed over the hopper outlets between adjacent ones of the valve modules, such that when the modular valve is assembled with the valve modules aligned and abutted, the hopper outlets substantially combine into a single, unified particle outlet that extends across a full width of the modular valve.

3. The modular particle valve of claim 1, wherein the valve modules are identical to each other.

4. The modular particle valve of claim 1, wherein at least one of the valve modules can be removed from the support structure and reinstalled in the support structure without substantially impacting a remainder of the valve modules, except for detachment therefrom and reattachment thereto.

5. The modular particle valve of claim 4, wherein the removal and the reinstallation of the at least one of the valve modules requires access only to distal ends or only to proximal ends of the valve modules.

6. The modular particle valve of claim 1, wherein the actuators are separately controlled, thereby enabling variation of a thickness of the particle curtain along its width.

7. The modular particle valve of claim 1, wherein at least one of the hopper assembly, the linkage, and the actuator of at least one of the valve modules is suspended from above by mounting hangers that are attached to the support structure.

8. The modular particle valve of claim 1, wherein the hopper abutting section of at least one of the moveable elements is substantially horizontal, and is translated distally and proximally by its associated actuator.

9. The modular particle valve of claim 1, wherein at least one of the moveable elements is suspended from a corresponding pivot, and wherein its associated actuator causes the forward edge of the hopper abutting section of the moveable element to approach and recede from the distal boundary of the hopper outlet by rotating the moveable element about the pivot.

10. A non-transient storage medium readable by a computing device, wherein:
the computing device is configured to control the actuators of a modular valve according to claim 1, and
the non-transient storage medium includes instructions that, when executed by the computing device, cause the computing device to direct the actuator of at least one of the modular valves to position the moveable element of the associated valve module such that particles contained in the hopper of the valve module fall through the open slot formed between the forward edge of the hopper abutting section of the moveable element of the valve module and the distal boundary of the hopper outlet of the valve module, thereby forming a curtain segment.

11. The non-transient storage medium of claim 10, wherein the instructions cause the computing device to direct the actuators of a group of adjacent valve modules of the plurality of valve modules to position the moveable elements of the group of adjacent valve modules such that particles contained in the hoppers of the group of adjacent valve modules form curtain segments by falling through the open slots formed between the forward edges of the hopper abutting section of the moveable elements of the group of adjacent valve modules and the distal boundaries of the hopper outlets of the group of adjacent valve modules, the curtain segments formed by the group of adjacent valve modules substantially merging together into a continuous particle curtain.

12. The non-transient storage medium of claim 11, wherein the instructions cause the computing device to direct the actuators of the group of adjacent valve modules of the plurality of valve modules to position the moveable elements of the group of adjacent valve modules such that a thickness of the continuous particle curtain is uniform across the continuous particle curtain.

13. The non-transient storage medium of claim 11, wherein the instructions cause the computing device to direct the actuators of the group of adjacent valve modules of the plurality of valve modules to position the moveable elements of the group of adjacent valve modules such that a thickness of the continuous particle curtain varies across the continuous particle curtain.

14. The non-transient storage medium of claim 13, wherein the instructions cause the computing device to direct the actuators of the group of adjacent valve modules of the plurality of valve modules to periodically or continuously reposition the moveable elements of the group of adjacent valve modules such that the non-uniformity of the thickness of the continuous particle curtain is adjusted according to changes in the ambient environment.

15. A solar energy collecting apparatus comprising:
a modular valve according to claim 1;
at least one solar collector configured to capture sunlight and direct the captured sunlight onto the continuous particle curtain formed by the modular valve; and
a particle collector configured to collect the particles of the continuous particle curtain after the exposure thereof to the collected sunlight, and to extract heat from the collected particles, said heat being generated by said directing of the collected sunlight onto the continuous particle curtain.
